(19) United States
(12) Patent Application Publication
(10) Pub. No.: US 2009/0172658 A1
(43) Pub. Date: Jul. 2, 2009

(54) APPLICATION INSTALLATION

(76) Inventors: Steven Wood, Boise, ID (US); Patrick Sewall, Boise, ID (US); David Alan Johnson, Boise, ID (US)

Correspondence Address: Zarian Midgley & Johnson PLLC, University Plaza, 960 Broadway Ave., Suite 250, Boise, ID, 83706, US

(21) Appl. No.: 12/350,405

(22) Filed: Jan. 8, 2009

Related U.S. Application Data
(63) Continuation-in-part of application No. 10/936,124, filed on Sep. 8, 2004.
(60) Provisional application No. 61/019,873, filed on Jan. 9, 2008.

(51) Int. Cl. G06F 9/445

(52) U.S. Cl. 717/174

(57) ABSTRACT

A method for installing an application includes detecting the initiation of a connection between a peripheral device and a client. An application state is determined. An active application state is an indication that the application has previously been installed. Upon a determination that the application state is not active, the application is installed on the client from the peripheral device, the application state is set to active, and the peripheral device is enabled to perform tasks as guided by the client.

### CROSS REFERENCE TO RELATED APPLICATIONS

This application claims the priority of provisional applications 61/019,873 entitled “Self-Installing Application From Router to Client Device” filed Jan. 9, 2008 which is hereby incorporated by reference. This application is a continuation in part of application Ser. No. 10/936,124 entitled Device Cradle filed Sep. 8, 2004. Application Ser. No. 10/936,124 is incorporated herein by reference.

### BACKGROUND

Peripheral devices such as routers, printers, scanners, and the like can connect to clients via wired and wireless interfaces. It can often prove beneficial to install an application to allow the client to interact with or otherwise obtain information from or about a connected peripheral device. Supplying such an application often involves including a CD ROM or other separate media source with the device requiring the user to manually locate and install the application.

### DESCRIPTION OF THE DRAWINGS

FIGS. 1 and 2 illustrate an exemplary block diagrams of environments in which embodiments of the present invention can be implemented.

FIGS. 3-6 are block diagrams showing physical and logical components of a Router according to an embodiment of the present invention.

FIGS. 7-8 are exemplary flow diagram illustrating steps taken in performance of various embodiments of the present invention.

### DETAILED DESCRIPTION

### Introduction

Various embodiments described below allow an application for interacting with a peripheral device to be automatically installed upon connection of the peripheral device to a client. A file or files for installing the application are stored in the memory of the peripheral device. In this manner, the device manufacturer need not include a separate installation source such as a CD ROM. Because the peripheral device already includes memory, manufacturing costs can be reduced.

### Environment

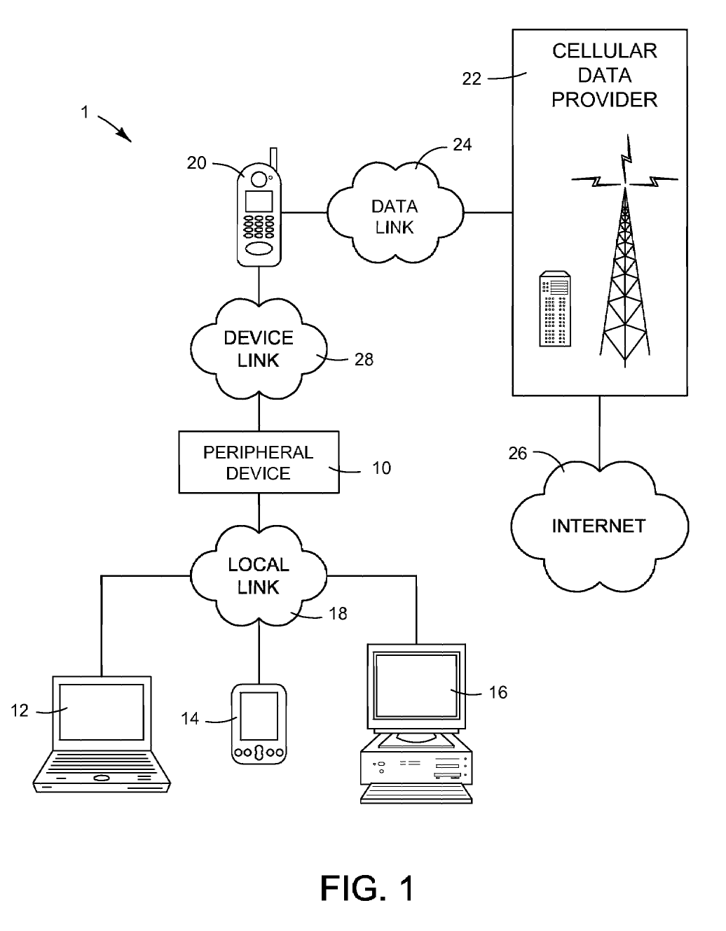

FIG. 1 illustrates exemplary environment 1 in which various embodiments of the present invention may be implemented. Environment 1 includes peripheral device 10 and clients 12, 14, and 16 and local link 18. Clients 12, 14, and 16 represent generally any computing devices capable of communicating with peripheral device 10. Peripheral device 10, discussed in more detail later, represents generally a device capable of connecting to clients 12, 14, and 16 and performing one or more tasks as guided by a connected client. In the following examples, peripheral device is described as a router device. However, implementation of various embodiments is not so limited. For example, peripheral device 10 could be a printer or a scanner.

Local link 18 interconnects peripheral device 10 and clients 12, 14, 16. Local link 18 represents generally a cable, wireless, or remote link via a telecommunication link, an infrared link, a radio frequency link, or any other connector or system that provides electronic communication between devices 10, 12, 14, and 16. The path followed by link 18 between devices 10, 12, 14, and 16 in the schematic view of FIG. 1 represents the logical communication path between these devices, not necessarily the physical path between the devices. Devices 10, 12, 14, and 16 can be connected at any point and the appropriate communication path established logically between the devices.

Environment 1 also includes data exchanger 20 and service provider 22. Data exchanger 20 represents generally and combination of hardware and programming that can be utilized by peripheral device 10 to connect to a remote network such as the internet. While illustrated as an internet enabled cellular telephone, data exchanger 20 is not so limited. Other examples include but are not limited to DSL modems and cable modems.

Service provider 22 represents generally any infrastructure configured to provide internet related data services to subscribers such as an owner of data exchanger 20. For example, where data exchanger 20 is an internet enabled cellular telephone, service provider 22 may be a cellular telephone service provider capable of providing voice and data services to subscribers allowing access to internet 26. Where data exchanger 22 is a DSL or cable modem, service provider 22 may be a more traditional internet service provider (ISP) providing data access to internet 26.

Remote link 24 interconnects data exchanger 20 and service provider 22 and represents generally any combination of a cable, wireless, or remote connection via a telecommunication link, an infrared link, a radio frequency link, or any other connector or system that provides electronic communication between data exchanger 20 and service provider 22.

In the embodiment illustrated in environment 1, device link 28 interconnects peripheral device 10 and data exchanger 20. Device link 28 represents generally any combination of a cable, wireless, or remote connection via a telecommunication link, an infrared link, a radio frequency link, or any other connector or system that provides electronic communication between devices 10 and 20. As examples, device link 28 may incorporate a physical USB cable or radio waves carrying Bluetooth or WiFi communications.

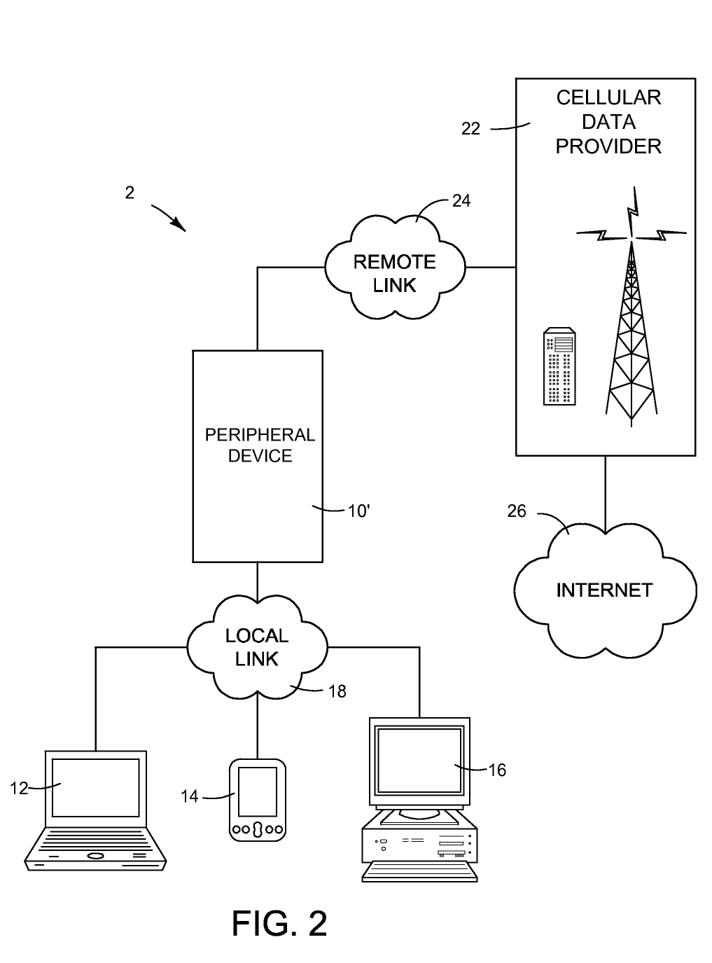

FIG. 2 illustrates another exemplary environment 2 in which various embodiments of the present invention may be implemented. In the example of FIG. 2, data exchanger 20 (not shown) and peripheral device 10′ are incorporated within the same device. Device link 32 (shown in FIG. 1) is eliminated and replaced with internal connections. In such a scenario, data exchanger may take the form of a separate device card that can be inserted into a slot provided by peripheral device 10, or otherwise connected to the peripheral device 10 through an I/O port. Alternatively, data exchanger 20 may be fully integrated into peripheral device 10.

### Peripheral Device

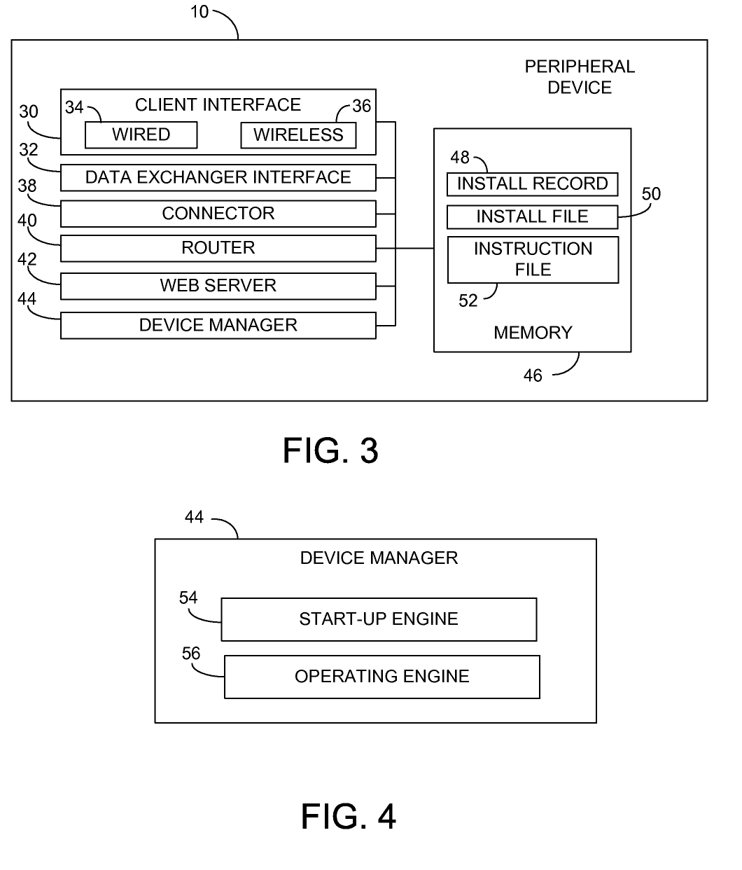

FIG. 3 is a block diagram illustrating physical and logical components of peripheral device 10. In this example, peripheral device 10 represents generally any combination of hardware and programming capable functioning as a router for directing network communications between clients on the local network, or between clients and the internet via a data exchanger such as an internet enabled cellular telephone, DSL modem, or cable modem. As noted above, peripheral device 10 may instead be a printer, scanner, or any other device capable of implementing a task under the guidance of a client.

In the example of FIG. 3 peripheral device 10 includes client interface 30 and data exchanger interface 32. Client interface 30 represents generally any combination of hardware and program instructions capable of supplying a communication interface between peripheral device 10 and clients 12, 14, and 16 shown in FIGS. 1 and 2. Data exchanger interface 32 represents any combination of hardware and programming enabling data to be communicated between peripheral device 10 and a data exchanger 20 shown in FIG. 1. Client interface 30 is shown to include wired interface 34 and wireless interface 36. Wired interface 34 represents generally any interface through which communications can pass between peripheral device 10 and clients 12, 14, and 16 via one or more physical wires. Wired interface 34 may include one or more serial or parallel ports including but not limited to USB and FireWire ports. Wireless interface 36 represents generally any interface through which information can be exchanged between peripheral device 10 and clients 12, 14, and 16 via a wireless protocol such as ultrawideband (UWB), Bluetooth, or 802.11. It is noted that, while peripheral device 10 is shown as including wired and wireless client interfaces 34 and 36, peripheral device 10 may include one or the other and not both.

Peripheral device 10 also includes connector 38, router 40, web server 42, device manager 44, and memory 46. Connector 38 represents generally any combination of hardware and programming for sending a signal to data exchanger 20 to connect to establish a data connection with service provider 22 so that access can be made to internet 26. For example, where a data exchanger 20 is a cellular telephone, connector 34 may send a signal causing the cellular telephone to establish such a data link with service provider 22.

Router 40 represents generally any combination of hardware and programming for routing network communication received through client interface 30 to be transmitted by data exchanger 20 to internet 26. Router 40 is also responsible for routing inbound network communications received from internet 26 and directed via client interface 30 to a specified client 12, 14, or 16. Outbound and inbound network communications, for example can be an IP (internet Protocol) packets directed to a target on internet 26 or to a particular network device 12, 14, or 16 on a local area network.

Web server 42 represents generally any combination of hardware and programming capable of serving interfaces such as web pages to clients 12, 14, and 16. Such web pages may include web pages that when displayed by a network device allows a user to provide or otherwise select settings related to the operation of peripheral device 10.

Device manager 44, discussed in more detail below with respect to FIGS. 4-6, represents generally any combination of hardware and programming capable of managing the configuration of peripheral device 10. One particular task assigned to device manager 44 is providing for the installation of an application on a client. In particular, device manager 44 is configured to detect the initiation of a connection between a client and client interface 30 and to determine an application state. The application state is an indication as to whether or not the application has already been installed on the client. Upon a determination that the application state is not active, device manager 44 provides for the installation of the application, sets the application state to active, and enables peripheral device 10 to perform tasks as guided by the client. For example, where as in this case, peripheral device 10 is a router device, those tasks include routing data communications to and from the connected client. In other implementations, such tasks could include printing documents, scanning images, and storing or retrieving data.

Memory 46 represents generally one or more computer readable mediums capable of storing data that is accessible to device manager 44 and web server 42. As shown memory 46 includes install record 48, install file 50, and instruction file 52. Install record 48 represents generally any data that can be used by device manager 44 to determine the application state. Install file 50 represents generally a program that can be executed by a client to install an application. Instruction file 52 represents generally a script that can be executed by an operating system of a client to cause that client to automatically execute install file 50. For example, device manager 44 can cause peripheral device 10 to appear as a mass storage device when connected to a client. As a result, the operating system of the client parses memory 46, locates and executes instruction file 52 resulting in the installation of the application. Where the operating system is Microsoft® Windows®, instruction file 52 may be referred to as an “autorun” file.

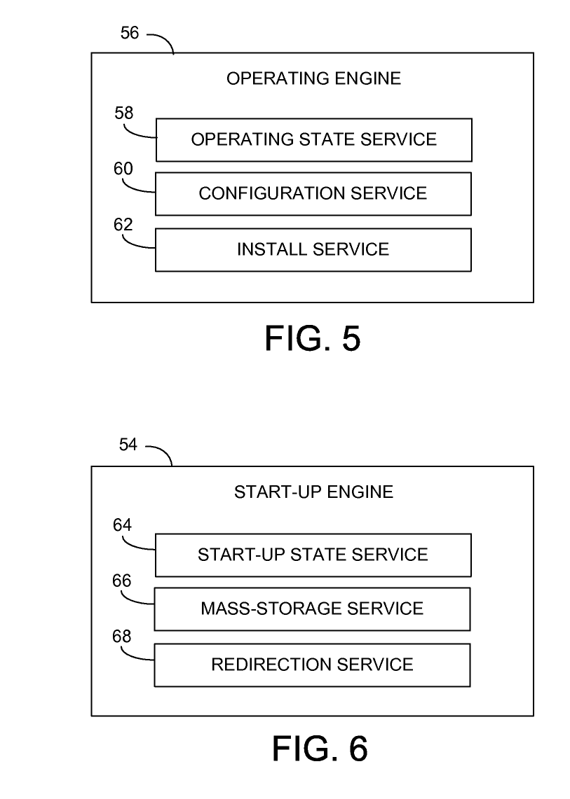

FIG. 4 is a block diagram illustrating physical and logical components of device manager 44. In this example, device manager 44 is shown to include start-up engine 54 and operating engine 56. Start-up engine 54 represents generally any combination of hardware and programming configured to provide for the installation of the application on a client. Start-up engine 54 is discussed in more detail below with respect to FIG. 6. Operating engine 56, discussed in more detail below with respect to FIG. 5, represents generally any combination of programming and hardware configured to manage the operational configuration of peripheral device 10.

Referring now to FIG. 5, operating engine 56 is shown to include operating state service 58, configuration service 60, and install service 62. Operating state service 58 represents generally any combination of hardware and programming configured to detect one or more operating states of peripheral device 10. Where, for example, peripheral device 10 is a router device, an operating state may be an indication of whether or not a data link has been established with a service provider as well as a strength level of such a connection.

Configuration service 60 represents generally any combination of hardware and programming configured to generate or otherwise supply one or more configuration web pages to web server 42 to be returned via web server 42 to a requesting client. The configuration pages may include information relating to the operating states detected by operating state service. The configuration pages may also include controls enabling a user to request changes to the operating state of peripheral device. Such changes are received by web server 42 and implemented by operating state service 58. Install service 62 represents generally any combination of hardware and programming configured to generate or otherwise supply one or more installation pages to web server 42 to be returned to a requesting client. The installation pages, when provided to a client, enable the client to download install file 50. The downloading of install file 50 may be manual or automatic. Furthermore, once downloaded, the install file 50 may be manually or automatically executed to install the application.

Referring to FIG. 6, start-up engine 54 is shown to include start-up state service 64, mass storage service 66, and redirection service 68. Start-up state service 64 represents generally any combination of hardware and programming configured to detect the initiation of a connection between client interface 30 and a client, to determine the application state, and to set or otherwise configure the application state. In particular, upon a determination that the application state is not active, start-up configuration service 64 is configured to utilize mass-storage service 66 if the detected connection is a wired connection or to utilize redirection service 68 if the detected connection is a wireless connection.

Mass-storage service 66 represents generally any combination of hardware and programming configured to present peripheral device 10 as a mass-storage device. When presented as a mass storage device with a wired connection to a client, the client can access and utilize memory 46. In particular, the operating system of the client will identify and execute instruction file 52, causing the client to execute installation file 50. Thus, when start-up state service 64 detects the initiation of a wired detection and determines that the application state is not active, start-up state service 64 causes mass-storage service 66 to present peripheral device 10 as a mass-storage device.

Redirection service 68 represents generally any combination of hardware and programming configured to redirect a request from a browser operating on a client to install service 62. When redirected, install service automatically causes or allows a user to download install file 50. Thus, when start-up state service 64 detects the initiation of a wireless detection and determines that the application state is not active, start-up state service 64 causes redirection service 68 to redirect the next or a subsequent browser request to install service 62. For example, where peripheral device is a router device, a browser operating on the client may request a page from the internet. Instead of outing the request, redirection service 68 causes install service 62 to return a web page that causes or allows a user to download install file 50.

Start-up state service 64 can be configured to detect the application state in a number of manners. As described, install record 48 (FIG. 3) represents generally any data that can be used by device manager 44 to determine the application state. In particular, install record 48 is utilized by start-up state service 64. In one implementation, install record 48 can be a flag that is either set or not set. A set flag, for example, may represent an active application state. When not set, the flag represents an application state that is not active. Thus, upon detecting the initiation of a connection between client interface 30 and a client, start-up state service 64 examines install record 48 to determine whether or not the flag is set. If not set, start-up state service 64 determines that the application state is not active and provides for the installation of the application. Subsequently, the start-up state service 64 sets the flag to configure the application state as active. Thus, when the initiation of a connection is again detected, start-up state service 64 examines install record 48, identifies that the flag is set, determines that the application state is active, and concludes that, at a minimum, an attempt has already been made to install the application. It is noted that the flag, by default, is not set. The flag is set only after start-up state service 64 has provided for the installation of the application. It is also noted that peripheral device 10 may include a feature to reset its settings to factory defaults. In such a case, resetting may configure the flag so that it is not set to indicate an application state that is no longer active.

In other implementations, install record 48 may be more complex. For example, install record 64 may include data identifying the client, data identifying the current version of the application, and data identifying the version of that application, if any, that is installed on the client. The data identifying the client may be the client's hardware address, network address, or user credentials used to initiate a connection with peripheral device 10. If the current version is newer than the installed version or if there is no installed version, then the application state is not active. Otherwise the application state is active. Thus, upon detecting the initiation of a connection between client interface 30 and a client, start-up state service 64 determines if the client is identified in install record 48. If not, the application state is determined to not be active. If the install record 48 identifies the client, start-up state service 64 compares the version of the application, if any, installed on the client with the current version. If no application is installed or if the current version is newer, the application state is determined not to be active. Otherwise, the application state is determined to be active. Upon determining that the application state is not active, start-up state service 64 provides for the installation of the application. Subsequently, start-up state service 64 updates install record 48 to reflect that the current version of the application has been installed on the client. Thus, when the initiation of a connection with that same client is again detected, start-up state service 64 examines install record 48, identifies that the installed version is the same as the current version and determines that the application state is active.

In another implementation, start-up state service 64 may be configured to determine the application state by querying the client connecting to client interface 30. In doing so, start-up state service 64 determines if the current version of the application is installed on the client. If so, the application state is active, otherwise, it is not.

As discussed, install file 50 (FIG. 3) represents generally a program that can be executed by a client to install an application. Install file 50 can take a number of forms. For example, install file 50 may be a self contained executable. Install file 50, when executed, may cause the client to access the internet and download and install the application. Install file 50 may be executable by a browser operating on the client to install the application in the form of a browser extension. That extension may be installed by install file 50, or install file 50 may cause the browser to download and install the extension.

Where peripheral device 10, as in FIG. 3, is a router device with access to internet 26, start-up state service 64 may periodically communicate via internet 26 to identify the current version of the application. Where install file 50 is a self contained executable and the current version is newer than the version stored in memory 46, start-up state service 64 downloads and stores the current version in memory 46 and updates install record 48 to reflect the current version. Where install record 48 is a flag, that flag is configured to reflect an application state that is not active. In other implementations, install record 48 is updated to identify the current application version. Where install file 50 is configured to download and install the application from internet 26, start-up state service 64 may, upon detection of the availability of a new version, update install record 48 to identify that that new version. In this manner, new application versions are installed on the client as they become available.

### Operation

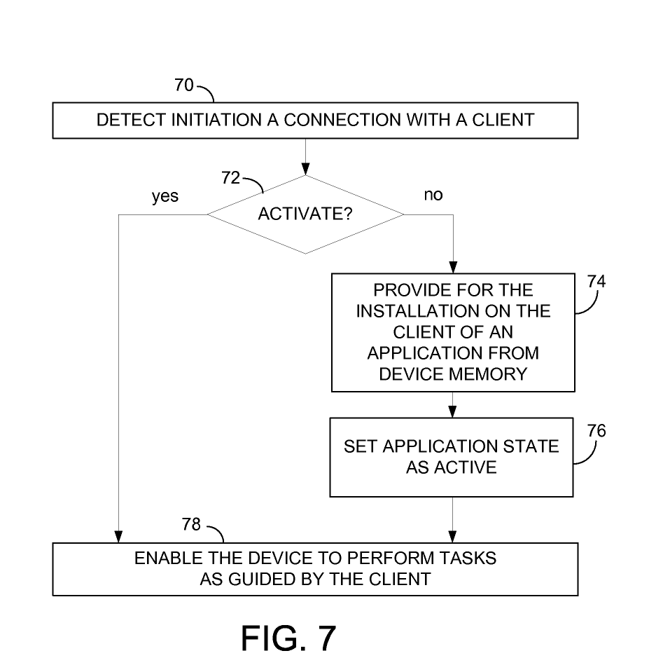

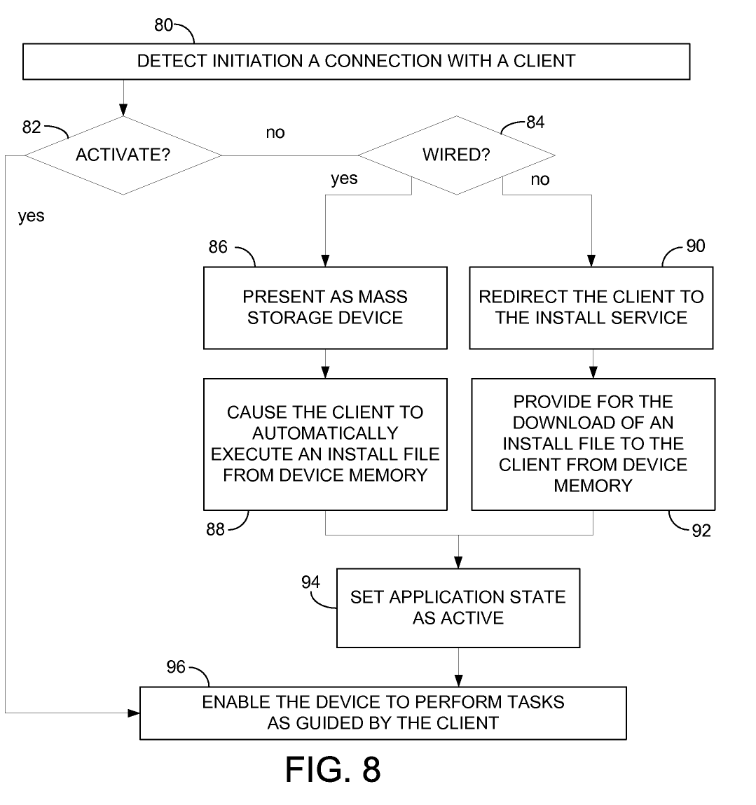

The operation of embodiments of the present invention will now be described with reference to FIGS. 7 and 8. FIG. 7 is an exemplary flow diagram that helps illustrate actions taken to provide for the installation of an application. FIG. 8 is an exemplary flow diagram that helps illustrate actions taken to provide for the installation of an application according to the type of connection detected between the peripheral device and a client.

Starting with FIG. 7, the initiation of a connection is detected (step 70). It is determined if the application state is active (step 72). In the Example of FIGS. 3 and 4, start-up engine 54 of device manager 44 may implement step 70 by detecting the initiation of a connection between a client and client interface 30. Start-up engine 54 may perform step 72 by examining install record 48 in one of the various manners discussed above. Alternatively, start-up engine 54 may query the client to determine if the current version of the application has already been installed. If, in step 72, the application state is determined not to be active, the process continues with step 74. Otherwise the process skips ahead to step 78.

Assuming the application state is determined not to be active, installation of the application on the client from device memory is provided for (step 74). The application state is set as active (step 76). The peripheral device is enabled to perform tasks as guided by the client (step 78). In the Example of FIGS. 3 and 4, start-up engine 54 may implement step 74 by causing, in one of a variety of possible manners, the client to execute install file 50 found in memory 46. Again, start-up engine 54 may implement step 76 by updating install record 48. Where for example, the peripheral device is a router device, step 78 involves allowing the peripheral device to route data communications to and from the client. Where the peripheral device is a printer, step 78 can involve allowing the peripheral device to receive and act on a print job.

Moving to FIG. 8, the initiation of a connection is detected (step 80). In the Example of FIGS. 3 and 4, start-up engine 54 of device manager 44 is responsible for detecting the initiation of a connection between a client and client interface 30. It is determined if the application state is active (step 82). Again referring to the examples of FIGS. 3 and 4, start-up engine 54 may perform step 82 by examining install record 48 in one of the various manners discussed above. Alternatively, start-up engine 52 may query the client to determine if the current version of the application has already been installed. If, in step 82, the application state is determined not to be active, the process continues with step 84. Otherwise the process skips ahead to step 96.

It is determined if the connection detected in step 80 is a wired connection (step 84). The alternative would be a wireless connection. If the connection is wired, the process continues with step 86. If wireless, the process continues with step 90. For a wired connection, the peripheral device is presented to the client as a mass-storage device (step 86). As a result the client is able to access the memory of the peripheral device. The client is caused to automatically execute an install file from that device memory (step 88). Referring back to FIG. 3, step 88 can involve maintaining instruction file 52 in memory 46. As described above, instruction file 52 includes instructions for executing install file 50. When the peripheral device is presented as a mass-storage device, the operating system of the client automatically executes instruction file 52 causing the client to execute install file 50.

If the connection detected in step 80 is wireless, the client is redirected to an install service (step 90). The download of the install file to the client device from the peripheral device memory is provided for (step 92). As an example, where peripheral device is a router device, a browser operating the client may used to request access to the internet. Instead of routing the request, start-up engine 54, in step 90, redirects the client to install service 62. Implementing step 92, install service 62 causes the browser to download the install file. Install service 62 may also cause the client to execute the install file. Alternatively, a user may be instructed to do so.

Once the client is provided with the install file in step 88 or step 92, the application state is set to active (step 94), and the peripheral device is enabled to perform tasks as guided by the client (step 96). Again, start-up engine 54 may implement step 94 by updating install record 48. Where for example, the peripheral device is a router device, step 96 involves allowing the peripheral device to route data communications to and from the client. Where the peripheral device is a printer, step 96 can involve allowing the peripheral device to receive and act on a print job.

### CONCLUSION

The schematic diagrams of FIGS. 1 and 2 illustrate exemplary environments in which embodiments of the present invention may be implemented. Implementation, however, is not limited to these environments. The diagrams of FIGS. 4-6 show the architecture, functionality, and operation of various embodiments of the present invention. A number of the blocks are defined as programs. Each of those blocks may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 7-8 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention.

What is claimed is:

1. A method for installing an application, comprising:
detecting the initiation of a connection between a peripheral device and a client;
determining an application state, wherein an active application state is an indication that the application has previously been installed;
upon a determination that the application state is not active, providing for the installation of the application on the client from the peripheral device, setting the application state to active, enabling the peripheral device to perform tasks as guided by the client; and
upon a determination that the application state is active, enabling the peripheral device to perform tasks as guided by the client.

2. The method of claim 1, wherein the peripheral device is a router device and wherein enabling the peripheral device to perform tasks as guided by the client comprises enabling the router device to route data communications to and from the client.

3. The method of claim 1, wherein the peripheral device includes a memory containing an install record configurable between a first state and a second state, and wherein:
determining comprises determining if the install record is configured in the first state, the first state reflecting the active application state; and
setting the application state to active comprises configuring the install record to the active state.

4. The method of claim 1, wherein the peripheral device includes a memory containing an install record, the install record identifying a current application version and an application version, if any, that is installed on the client, and wherein:
determining comprises examining the install record to compare the current application version with the installed application version, if any, wherein the application state is active only if the comparison reveals that the current version is not newer than the installed version;
setting comprises updating the install record to reflect that the current application version has been installed on the client.

5. The method of claim 1, wherein the peripheral device includes a memory containing an install file for the application, and wherein:
detecting comprises detecting the initiation of a wired connection between the peripheral device and the client; and
providing for the installation comprises presenting the peripheral device as a mass storage device and causing the client to automatically execute the install file from the peripheral device memory.

6. The method of claim 5, wherein causing the client to automatically execute the install file from the peripheral device memory comprises providing an instruction file in the memory, the instruction file capable of being automatically parsed by an operating system of the client to cause the client to automatically execute the install file from the memory.

7. The method of claim 1, wherein the peripheral device includes a memory containing an install file for the application, and wherein:
detecting comprises detecting the initiation of a wireless connection between the peripheral device and the client; and
providing for the installation comprises redirecting the client to an install service provided by the peripheral device, the install service providing for the download of the install file to the client from the peripheral device memory.

8. The method of claim 7, wherein redirecting the client to an install service provided by the peripheral device comprises, upon receiving a communication from a browser operating on the client, redirecting the browser to the install service provided by the peripheral device.

9. The method of claim 1, wherein the peripheral device includes a memory containing an install file for the application, the method further comprising determining if the connection between the peripheral device and the client peripheral device is a wired or a wireless connection, and wherein providing for the installation comprises:
upon a determination that the connection is a wired connection, presenting the peripheral device as a mass storage device and causing the client to automatically execute the install file from the peripheral device memory; and
upon a determination that the connection is a wireless connection, redirecting the client to an install service provided by the peripheral device, the install service providing for the download of the install file to the client from the peripheral device memory.

10. A computer readable medium having instructions that when executed cause a peripheral device to implement a method, the medium including instructions for:
detecting the initiation of a connection between a peripheral device and a client;
determining an application state, wherein an active application state is an indication that the application has previously been installed;
upon a determination that the application state is not active, providing for the installation of the application on the client from the peripheral device, setting the application state to active, enabling the peripheral device to route data communications to and from the client; and
upon a determination that the application state is active, enabling the peripheral device to route data communications to and from the client.

11. The medium of claim 10, wherein the peripheral device is a router device and wherein the instructions for enabling the peripheral device to perform tasks as guided by the client include instructions for enabling the router device to route data communications to and from the client.

12. The method of claim 10, wherein the peripheral device includes a memory containing an install record configurable between a first state and a second state, and wherein:
determining comprises determining if the install record is configured in the first state, the first state reflecting the active application state; and
setting the application state to active comprises configuring the install record to the active state.

13. The medium of claim 10, wherein the peripheral device includes a memory containing an install record, the install record identifying a current application version and an application version, if any, that is installed on the client, and wherein:
the instructions for determining include instructions for examining the install record to compare the current application version with the installed application version, if any, wherein the application state is active only if the comparison reveals that the current version is not newer than the installed version;
the instructions for setting include instructions for updating the install record to reflect that the current application version has been installed on the client.

14. The medium of claim 10, wherein the peripheral device includes a memory containing an install file for the application, and wherein:
the instructions for detecting include instructions for detecting the initiation of a wired connection between the peripheral device and the client; and
the instructions for providing for the installation include instructions for presenting the peripheral device as a mass storage device and causing the client to automatically execute the install file from the peripheral device memory.

15. The medium of claim 14, wherein the instructions for causing the client to automatically execute the install file from the peripheral device memory include an instruction file in the memory, the instruction file capable of being automatically parsed by an operating system of the client to cause the client to automatically execute the install file from the memory.

16. The medium of claim 10, wherein the peripheral device includes a memory containing an install file for the application, and wherein:
the instructions for detecting include instructions for detecting the initiation of a wireless connection between the peripheral device and the client; and
the instructions for providing for the installation include instructions for redirecting the client to an install service provided by the peripheral device, the install service providing for the download of the install file to the client from the peripheral device memory.

17. The medium of claim 16, wherein the instructions for redirecting the client to an install service provided by the peripheral device include instructions for redirecting, upon receiving a communication from a browser operating on the client, the browser to the install service provided by the peripheral device.

18. The medium of claim 10, wherein the peripheral device includes a memory containing an install file for the application, the medium including further instructions for determining if the connection between the peripheral device and the client peripheral device is a wired or a wireless connection, and wherein the instructions for providing for the installation include instructions for:
upon a determination that the connection is a wired connection, presenting the peripheral device as a mass storage device and causing the client to automatically execute the install file from the peripheral device memory; and
upon a determination that the connection is a wireless connection, redirecting the client to an install service provided by the peripheral device, the install service providing for the download of the install file to the client from the peripheral device memory.

19. A peripheral device comprising a client interface and a start-up engine, wherein the start-up engine is configured to:
detect the initiation of a connection between the client interface and a client via the client interface;
determining an application state, wherein an active application state is an indication that the application has previously been installed;
upon a determination that the application state is not active, providing for the installation of the application on the client from the peripheral device, setting the application state to active, enabling the peripheral device to perform tasks as guided by the client; and
upon a determination that the application state is active, enabling the peripheral device to perform tasks as guided by the client.

20. The peripheral device of claim 19, further comprising a router and wherein the start-up engine is configured to enabling the peripheral device to perform tasks as guided by the client by enabling the router to route data communications to and from the client.

21. The peripheral device of claim 19, further comprising a memory containing an install record configurable between a first state and a second state, and wherein the start-up engine is configured to:
determine the application state by determining if the install record is configured in the first state, the first state reflecting the active application state; and
set the application state to active by configuring the install record to the active state.

22. The peripheral device of claim 19, further comprising a memory containing an install record, the install record identifying a current application version and an application version, if any, that is installed on the client, and wherein the start-up engine is configured to:
determine the application state by examining the install record to compare the current application version with the installed application version, if any, wherein the application state is active only if the comparison reveals that the current version is not newer than the installed version;
set the application state to active by updating the install record to reflect that the current application version has been installed on the client.

23. The peripheral device of claim 19, wherein the peripheral device includes a memory containing an install file for the application, and wherein the start-up engine is configured to:
detect the initiation of a wired connection between the peripheral device and the client via the client interface; and
provide for the installation by presenting the peripheral device as a mass storage device and causing the client to automatically execute the install file from the peripheral device memory.

24. The peripheral device of claim 23, wherein the start-up engine is configured to cause the client to automatically execute the install file from the peripheral device memory by providing an instruction file in the memory, the instruction file capable of being automatically parsed by an operating system of the client to cause the client to automatically execute the install file from the memory.

25. The peripheral device of claim 19, wherein the peripheral device includes a memory containing an install file for the application, and wherein the start-up engine is configured to:
detect the initiation of a wireless connection between the peripheral device and the client via the client interface; and
providing for the installation by redirecting the client to an install service provided by the peripheral device, the install service providing for the download of the install file to the client from the peripheral device memory.

26. The peripheral device of claim 25, wherein the start-up engine is configured to redirect the client to an install service provided by the peripheral device by redirecting a browser operating on the client to the install service upon receiving a communication from the browser.

27. The peripheral device of claim 19, wherein the peripheral device includes a memory containing an install file for the application, wherein the start-up engine is operable to determine if the connection between the peripheral device and the client peripheral device is a wired or a wireless connection provided via the client interface, and wherein the start-up engine is operable to provide for the installation by:
upon a determination that the connection is a wired connection, presenting the peripheral device as a mass storage device and causing the client to automatically execute the install file from the peripheral device memory; and
upon a determination that the connection is a wireless connection, redirecting the client to an install service provided by the peripheral device, the install service providing for the download of the install file to the client from the peripheral device memory.
